(19) United States
(12) Patent Application Publication
(10) Pub. No.: US 2006/0022992 A1
(43) Pub. Date: Feb. 2, 2006

(54) Information processing apparatus and method for controlling display luminance

(75) Inventors: Kazuhiko Tsuji, Tokyo (JP); Hiroki Takenouchi, Tokyo (JP); Shigeharu Imamura, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/192,290

(22) Filed: Jul. 29, 2005

(30) Foreign Application Priority Data
Jul. 30, 2004 (JP) P2004-224140

(51) Int. Cl. G09G 5/02

(52) U.S. Cl. 345/589

(57) ABSTRACT

An information processing apparatus includes a display device, an input unit, a determining unit and a processing unit. The input unit inputs an event instructing to change display luminance of the display device. The determining unit determines as to which one of a battery and an external power supply drives the apparatus. The processing unit changes the display luminance in a range of a first luminance value to a second luminance value being larger than the first luminance value in accordance with the input event when the determining unit determines that the external power supply drives the apparatus. The processing unit changes the display luminance in a range of a third luminance value to a fourth luminance value being larger than the third luminance value and being smaller than the second luminance value in accordance with the input event when the determining unit determines that the battery drives the apparatus.

This application is based upon and claims the benefit of priority from the prior Japanese Patent Application No. 2004-224140 filed on Jul. 30, 2004, the entire contents of which are incorporated herein by reference.

### BACKGROUND OF THE INVENTION

1. Field of the Invention

The invention relates to an information processing apparatus such as a personal computer and a method for controlling display luminance used in the apparatus.

2. Description of the Related Art

In recent years, a personal computer having an AV function like an audiovisual (AV) machine such as a DVD (Digital Versatile Disk) player or a TV has been developed.

Such a personal computer uses a display having high display luminance to make it possible to display video data brightly and sharply.

JP Hei. 6-102974 A discloses a personal computer having a function of increasing or decreasing the display luminance of a display device in response to operation of a hot key. The user can adjust the display luminance as desired by operating the hot key.

### BRIEF SUMMARY OF THE INVENTION

However, there is a possibility that very high display luminance equivalent to that of a dedicated TV will be required for the personal computer having the AV function. As the display luminance value becomes higher, the power consumption of the display device increases accordingly.

Thus, when the personal computer is operated with a battery, if the user operates the hot key to increase the display luminance value to the maximum luminance value of the display device, there is a danger that the power consumption value of the system may exceed the maximum supply power value of the battery. In this case, trouble such that the operation speed of the system is remarkably decreased occurs. If the operation speed of the system decreases, it becomes difficult to smoothly play back video data.

The invention provides an information processing apparatus and a method for controlling display luminance, to making it possible to appropriately change the display luminance value in response to a driving power supply.

### BRIEF DESCRIPTION OF THE DRAWINGS

In the accompanying drawings:

FIG. 1 is a perspective view to show an outline of a computer according to one embodiment of the invention

FIG. 2 is a block diagram to show the system configuration of the computer in FIG. 1;

FIG. 3 is a drawing to show a first display luminance table used with the computer in FIG. 1;

FIG. 4 is a drawing to show a second display luminance table used with the computer in FIG. 1;

FIG. 5 is a flowchart to show a procedure of display luminance table selection processing at the power on time, executed by the computer in FIG. 1;

FIG. 6 is a flowchart to show a procedure of display luminance table switching processing executed by the computer in FIG. 1;

FIG. 7 is a flowchart to show a procedure of display luminance level change processing executed by the computer in FIG. 1; and

FIG. 8 is a drawing to show a manner in which display luminance is changed by the computer in FIG. 1.

### DETAILED DESCRIPTION OF THE EMBODIMENTS

Referring now to the accompanying drawings, preferred embodiments of the invention will be described.

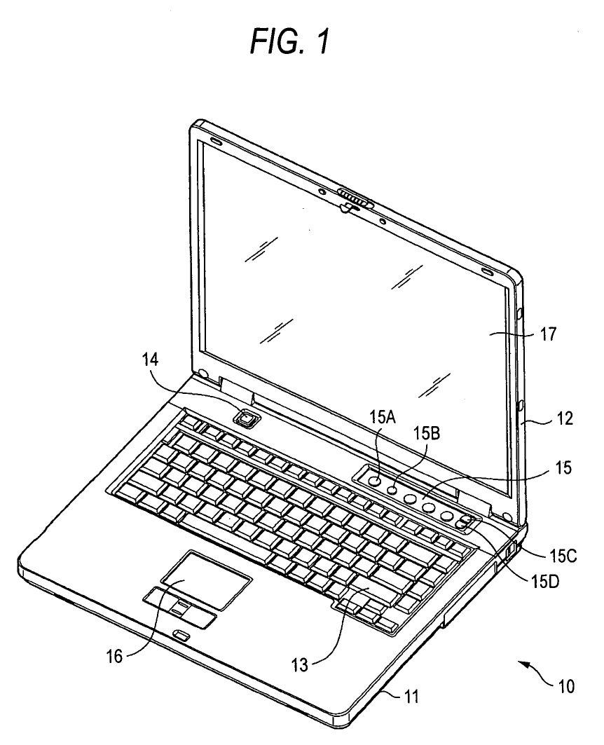

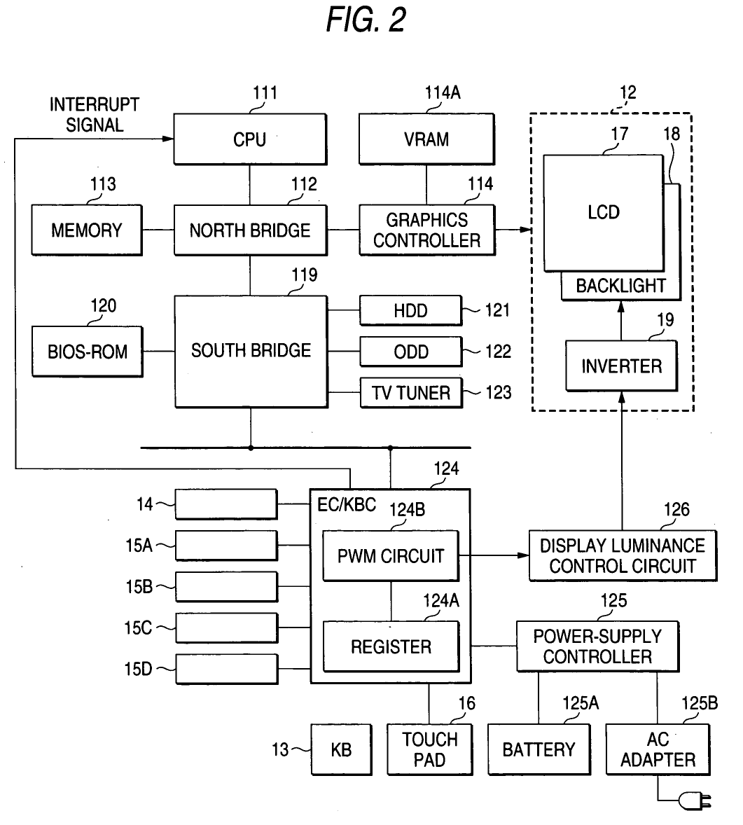

To begin with, the configuration of an information processing apparatus according to one embodiment of the invention will be discussed with reference to FIGS. 1 and 2. This information processing apparatus is implemented as a notebook personal computer 10, for example.

FIG. 1 is a front view of the notebook personal computer 10 in a state in which a display unit is open. The computer 10 can be operated with a battery. The computer 10 includes a computer main unit 11 and a display unit 12. A display implemented as an LCD (Liquid Crystal Display) 17 is incorporated in the display unit 12, and a display screen of the LCD 17 is positioned almost in the center of the display unit 12. The LCD 17 is formed of a transmission liquid crystal panel. In the display unit 12, a backlight 18 (see FIG. 2) is placed in the rear of the LCD 17. The backlight 18 serves as a lighting unit of the display unit 12. The backlight 18 includes a fluorescent lamp such as a cold cathode fluorescent lamp (CCFL) as a lighting unit.

The display unit 12 is attached so as to be rotatable between an open position and a closed position relative to the computer main unit 11. The computer main unit 11 has a cabinet shaped like a thin box on which a keyboard 13, a power button 14 for turning on/off power of the computer 10, an input operation panel 15, a touch pad 16, and the like are placed.

The input operation panel 15 is an input unit for inputting an event corresponding to a pressed button, and includes a plurality of buttons for starting a plurality of functions. The buttons also include a TV start button 15A and a DVD/CD start button 15B. The TV start button 15A is a button switch for starting a TV function to play back and record TV broadcast program data. When the user presses the TV start button 15A, a TV application program for executing the TV function is automatically started.

A suboperating system dedicated to processing of AV (audiovisual) data as well as a main versatile operating system is installed in the computer 10. The TV application program is a program operating in the suboperating system.

When the user presses the power button 14, the main operating system is started. On the other hand, when the user presses the TV start button 15A, the suboperating system rather than the main operating system is started and the TV application program is automatically executed. The suboperating system has only the minimum function for executing the AV function. Thus, the time required for boot-up of the suboperating system is far shorter that the time required for boot-up of the main operating system. Thus, the user can instantly view or record a TV program simply by pressing the TV start button 15A.

The DVD/CD start button 15B is a button switch for playing back video content recorded on a DVD or a CD. When the user presses the DVD/CD start button 15B, a video playback application program for playing back video content is automatically started. The video playback application program is also an application program operating in the suboperating system. When the user presses the DVD/CD start button 15B, the suboperating system rather than the main operating system is started and the video playback application program is automatically executed.

Further, the input operation panel 15 also includes luminance control buttons 15C and 15D. Each of the luminance control buttons 15C and 15D is a button switch for entering a luminance control event, which instructs to change the display luminance of the LCD 17. The user uses the luminance control button 15C to enter a luminance control event, which instructs to increase the display luminance (display luminance increase event), and the luminance control button 15D to enter a luminance control event, which instructs to decrease the display luminance (display luminance decrease event).

Next, the system configuration of the computer 10 will be discussed with reference to FIG. 2.

The computer 10 includes a CPU 111, a north bridge 112, main memory 113, a graphics controller 114, a south bridge 119, BIOS-ROM 120, a hard disk drive (HDD) 121, an optical disk drive (ODD) 122, a TV tuner 123, an embedded controller/keyboard controller IC (EC/KBC) 124, a power-supply controller 125, and a display luminance control circuit 126, as shown in FIG. 2.

The CPU 111 is a processor provided for controlling the operation of the computer 10 and executes the main operating system (main OS), the suboperating system (subOS), and various application programs loaded into the main memory 113 from the hard disk drive (HDD) 121.

The CPU 111 also executes BIOS (Basic Input Output Program) stored in the BIOS-ROM 120. The BIOS is a hardware control program and has a function of controlling the display luminance of the LCD 17. To control the display luminance, the luminance of the backlight 18 placed in the rear of the LCD 17 is controlled. To control the display luminance of the LCD 17, the BIOS selectively uses two types of tables of first and second display luminance tables.

The first display luminance table provides display luminance control information used when the computer 10 is operated with an external power supply from an AC adapter 125B (external AC power supply). The first display luminance table defines a plurality of luminance values in the range of the minimum luminance value to a first maximum luminance value. When the computer 10 is operated with the external power supply from the AC adapter 125B (external AC power supply), namely, is AC-operated, the BIOS controls the display luminance of the LCD 17 based on the first display luminance table. In this case, the display luminance of the LCD 17 can be changed in the range of the minimum luminance value to the first maximum luminance value defined in the first display luminance table. The display luminance is changed in response to operation of the luminance control button 15C or 15D. When the luminance control button 15C is pressed, the BIOS executes processing of setting the display luminance of the LCD 17 to the luminance value one level higher than the current display luminance value based on the first display luminance table. The upper limit of the changeable display luminance value is the first maximum luminance value. On the other hand, when the luminance control button 15D is pressed, the BIOS executes processing of setting the display luminance of the LCD 17 to the luminance value one level lower than the current display luminance value based on the first display luminance table.

The second display luminance table provides display luminance control information used when the computer 10 is operated with a battery 125A, namely, is battery-operated. The second display luminance table defines a plurality of luminance values in the range of the minimum luminance value to a second maximum luminance value. The second maximum luminance value is lower than the first maximum luminance value defined in the first display luminance table. The second maximum luminance value is determined based on a value resulting from subtracting the total current consumption value of components, which make up the computer 10, other than the backlight 18 from the current capacity value of the battery 125A (rated current capacity). For example, if the current capacity value of the battery 125A is N amperes and the total current consumption value of the components other than the backlight 18 is K amperes, the second maximum luminance value is determined so that the maximum current consumption value of the backlight 18 becomes N-K amperes.

If the AC adapter 125B is not connected to the computer 10 and the computer 10 is operated with the battery 125A (when the computer 10 is battery-operated), the BIOS controls the display luminance of the LCD 17 based on the second display luminance table. In this case, the display luminance of the LCD 17 can be changed in the range of the minimum luminance value to the second maximum luminance value defined in the second display luminance table. The display luminance is changed in response to operation of the luminance control button 15C or 15D. When the luminance control button 15C is pressed, the BIOS executes processing of setting the display luminance of the LCD 17 to the luminance value one level higher than the current display luminance value based on the second display luminance table. The upper limit of the changeable display luminance value is the second maximum luminance value. Accordingly, it can be prevented that a situation occurs in which the power consumption value of the system exceeds the maximum supply power value of the battery. On the other hand, when the luminance control button 15D is pressed, the BIOS executes processing of setting the display luminance of the LCD 17 to the luminance value one level lower than the current display luminance value based on the second display luminance table.

The north bridge 112 is a bridge device for connecting a local bus of the CPU 111 and the south bridge 119. The north bridge 112 also contains a memory controller for controlling access to the main memory 113. The north bridge 112 also has a function of executing communications with the graphics controller 114 through an AGP (Accelerated Graphics Port) bus, etc.

The graphics controller 114 is a display controller for controlling the LCD 17 used as a display monitor of the computer 10. The graphics controller 114 has video memory (VRAM) 114A and generates a video signal for forming a display image to be displayed on the LCD 17, from the display data written into the video memory 114A by an OS/application program.

The south bridge 119 controls devices on an LPC (Low Pin Count) bus. The south bridge 119 also contains an IDE (Integrated Drive Electronics) controller for controlling the HDD 121 and the ODD 122. Further, the south bridge 119 also has a function of controlling the TV tuner 123 and a function of controlling access to the BIOS-ROM 120.

The HDD 121 is a storage unit for storing various types of software and various pieces of data. Not only the main operating system, but also the suboperating system is installed in the HDD 121, as described above.

The optical disk drive (ODD) 122 is a drive unit for driving storage media such as a DVD and a CD storing video content. The TV tuner 123 is a receiver for receiving external broadcast program data such as TV broadcast programs.

The embedded controller/keyboard controller IC (EC/KBC) 124 is a one-chip microcomputer into which an embedded controller for power management and a keyboard controller for controlling the keyboard (KB) 13 and the touch pad 16 are integrated. When the user presses the luminance control button 15C or 15D, the embedded controller/keyboard controller IC (EC/KBC) 124 generates and sends an interrupt signal, such as SMI (System Management Interrupt), to the CPU 111 to notify the BIOS that a luminance control event (display luminance increase or decrease event) is entered. The embedded controller/keyboard controller IC (EC/KBC) 124 can also conduct communications with the power-supply controller 125. When an event indicating attachment or detachment of the AC adapter 125B is input from the power-supply controller 125, the embedded controller/keyboard controller IC (EC/KBC) 124 also generates and sends an interrupt signal to the CPU 111 to notify the BIOS that the event is input.

The embedded controller/keyboard controller IC (EC/KBC) 124 has a function of turning on/off the power of the computer 10 in response to user's operation of the power button 14 in cooperation with the power-supply controller 125. Further, the embedded controller/keyboard controller IC (EC/KBC) 124 can also turn on the power of the computer 10 in response to user's operation of the TV start button 15A or the DVD/CD start button 15B in cooperation with the power-supply controller 125.

The embedded controller/keyboard controller IC (EC/KBC) 124 is provided with a luminance control register 124A and a PWM (Pulse Width Modulation) circuit 124B as a hardware logic for controlling the display luminance. The luminance control register 124A is an I/O register that can be read and written by the CPU 111. The BIOS writes the display luminance control data corresponding to the target display luminance value into the luminance control register 124A. The PWM circuit 124B generates a PWM signal corresponding to the display luminance control data written into the luminance control register 124A. The duty ratio of the PWM signal changes with the value of the display luminance control data. For example, if the display luminance control data corresponding to the first maximum luminance value described above is set in the luminance control register 124A, the PWM signal with the duty ratio=1 is generated from the PWM circuit 124B and is sent to the display luminance control circuit 126.

The display luminance control circuit 126 converts the PWM signal sent from the PWM circuit 124B into a luminance control voltage to control the luminance of the backlight 18. The voltage value of the luminance control voltage changes in accordance with the duty ratio of the PWM signal. When the duty ratio of the PWM signal is 1, the voltage value of the luminance control voltage becomes the maximum value. The display unit 12 is provided with an inverter circuit 19 for controlling the luminance of the backlight 18 in response to the luminance control voltage applied from the display luminance control circuit 126.

The power-supply controller 125 generates a system power supply to start the components of the computer 10 from the external power supply through the AC adapter 125B or the battery 125A. The power-supply controller 125 detects as to whether or not the AC adapter 125B is connected to the computer 10, in response to the presence or absence of power supply from the AC adapter 125B. The detection result is set in a status register in the power-supply controller 125 as an AC/battery flag. If the AC adapter 125B is connected to the computer 10, the power-supply controller 125 generates the system power supply from the external power supply and also charges the battery 125A. On the other hand, if the AC adapter 125B is not connected to the computer 10, the power-supply controller 125 generates the system power supply from the battery 125A.

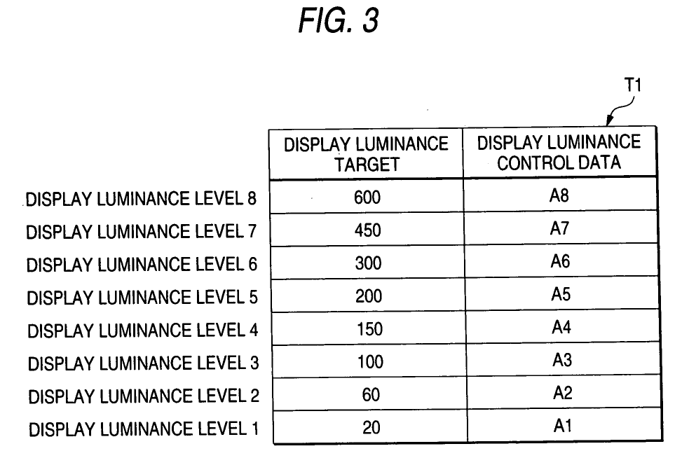

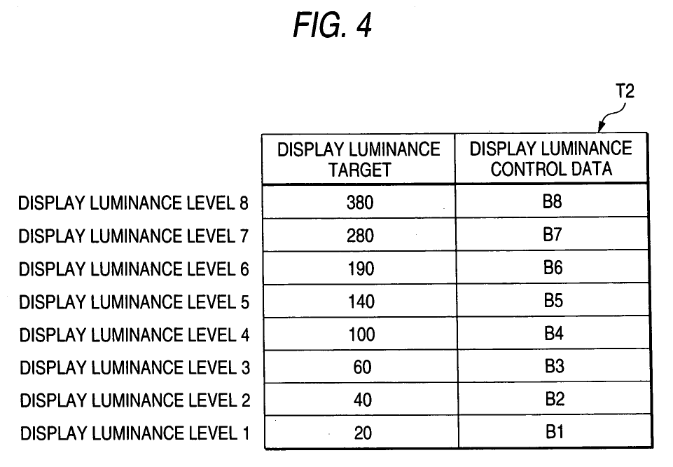

Next, a first display luminance table T1 used in the AC-operated mode and a second display luminance table T2 used in the battery-operated mode will be discussed with reference to FIGS. 3 and 4.

FIG. 3 shows an example of the first display luminance table T1. The first display luminance table T1 defines a plurality of pieces of luminance control information provided in a one-to-one correspondence with eight display luminance levels 1 to 8. Each piece of luminance control information has a display luminance target and display luminance control data corresponding to the display luminance target.

Each display luminance target indicates a value of the display luminance to be set (cd/m²). The maximum value of the display luminance target in the AC-operated mode (display luminance level=8) is 600 candelas/square meter (cd/m²), for example. In a state in which the display luminance of the LCD 17 is set to 600 candelas/square meter (cd/m²), video data of a TV broadcast program, etc., can be displayed on the LCD 17 brightly and sharply like a dedicated TV. The minimum value of the display luminance target in the AC-operated mode (display luminance level=1) is 20 candelas/square meter (cd/m²), for example.

The power consumption of the display unit 12 increases as the display luminance of the LCD 17 becomes higher. In the AC-operated mode, the computer 10 can receive external sufficient power, so that the user can increase or decrease the display luminance of the LCD 17 as desired in the range of 20 candelas/square meter to 600 candelas/square meter simply by operating the luminance control button 15C or 15D.

Each display luminance control data indicates a value of the data to be set in the luminance control register 124A. The value of the display luminance control data is predetermined in response to the value of the corresponding display luminance target. The display luminance control data is 16-bit binary data, for example. Note that A1 to A8 in FIG. 3 virtually denote the values of the display luminance control data corresponding to the display luminance levels 1 to 8 and are not actual values of the display luminance control data.

One of the display luminance levels 1 to 8 is used as the default display luminance in the AC-operated mode. For example, the display luminance level 5 is the default display luminance level in the AC-operated mode. If the power of the computer 10 is turned on with the computer 10 connected to the AC adapter 125B, the BIOS writes the display luminance control data A5 corresponding to the display luminance level 5 into the luminance control register 124A, thereby setting the display luminance of the LCD 17 to the display luminance value corresponding to the display luminance level 5 (200 candelas/square meter).

FIG. 4 shows an example of the second display luminance table T2. The second display luminance table T2 also defines a plurality of pieces of luminance control information provided in a one-to-one correspondence with eight display luminance levels 1 to 8. The maximum value of the display luminance target defined in the second display luminance table T2 (display luminance level=8) is 380 candelas/square meter (cd/m²), for example; it is set lower than the maximum value of the display luminance target defined in the first display luminance table T1. The minimum value of the display luminance target defined in the second display luminance table T2 (display luminance level=1) is the same as the minimum value of the display luminance target defined in the first display luminance table T1 (20 candelas/square meter). Values of the display luminance control data, B1 to B8, in FIG. 4 virtually denote the values of the display luminance control data corresponding to the display luminance levels 1 to 8.

One of the display luminance levels 1 to 8 is used as the default display luminance in the battery-operated mode. For example, the display luminance level 5 is the default display luminance level in the battery-operated mode. If the power of the computer 10 is turned on with the computer 10 not connected to the AC adapter 125B, the BIOS writes the display luminance control data B5 corresponding to the display luminance level 5 into the luminance control register 124A, thereby setting the display luminance of the LCD 17 to the display luminance value corresponding to the display luminance level 5 (140 candelas/square meter).

When the computer 10 is operated with the battery, the user can also increase or decrease the display luminance of the LCD 17 by operating the luminance control button 15C or 15D. However, the maximum display luminance value of the LCD 17 that can be set is limited to 380 candelas/square meter. Thus, if the user increases or decreases the display luminance of the LCD 17 by operating the luminance control button 15C or 15D, a situation in which the total power consumption of the system exceeds the current capacity of the battery 125A does not occur.

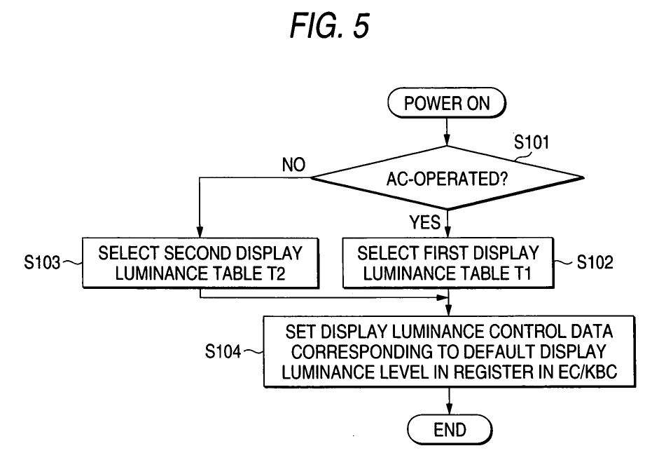

Next, display luminance setting processing executed by the BIOS will be discussed with reference to a flowchart of FIG. 5.

The display luminance setting processing is processing executed when the power of the computer 10 is turned on.

First, the BIOS executes processing of determining as to whether or not the computer 10 is operated with the external power supply, namely, is AC-operated (step S101). At step S101, the BIOS checks the AC/battery flag set in the status register in the power-supply controller 125 through the embedded controller/keyboard controller IC 124. When it is determined that the computer 10 is AC-operated (YES at step S101), the BIOS selects the first display luminance table T1 (step S102). On the other hand, when it is determined that the computer 10 is not AC-operated (NO at step S101), the BIOS selects the second display luminance table T2 (step S103).

After this, the BIOS acquires the display luminance control data corresponding to the default display luminance level from the selected display luminance table and sets the acquired display luminance control data in the luminance control register 124A in the embedded controller/keyboard controller IC 124 (step S104). Accordingly, when the computer 10 is AC-operated, the display luminance of the LCD 17 is initialized to the display luminance corresponding to the default display luminance level 5 (200 candelas/square meter) When the computer 10 is battery-operated, the display luminance of the LCD 17 is initialized to the display luminance corresponding to the default display luminance level 5 (140 candelas/square meter).

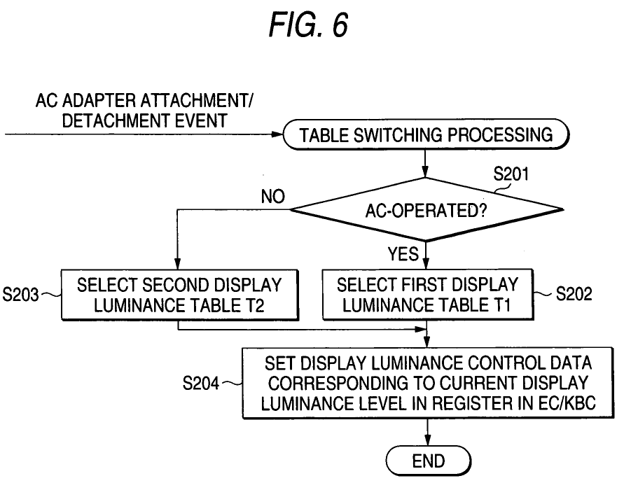

Next, display luminance table switching processing executed by the BIOS will be discussed with reference to a flowchart of FIG. 6.

The display luminance table switching processing is executed when the user attaches or detaches the AC adapter 125B after the computer 10 is started.

When the AC adapter 125B is connected to the computer 10 or when the AC adapter 125B is detached from the computer 10, the embedded controller/keyboard controller IC 124 generates and sends an interrupt signal to the CPU 111 to notify the BIOS that an AC adapter attachment/detachment event occurs. The BIOS executes the following processing in response to the interrupt signal:

First, the BIOS executes processing of referencing the AC/battery flag set in the status register in the power-supply controller 125 and determining as to whether or not the computer 10 is operated with the external power supply at present, namely, is AC-operated (step S201).

When it is determined that the computer 10 is AC-operated (YES at step S201), the BIOS determines that the computer 10 is switched from battery-operated to AC-operated, and selects the first display luminance table T1 (step S202). Accordingly, the display luminance table to be used is switched from the second display luminance table T2 to the first display luminance table T1. After this, the BIOS acquires the display luminance control data corresponding to the current display luminance level having been used until just before the AC adapter 125B is connected from the first display luminance table T1, and sets the acquired display luminance control data in the luminance control register 124A in the embedded controller/keyboard controller IC 124 (step S204). As a result, for example, if the current display luminance level having been used until just before the AC adapter 125B is connected is the maximum display luminance level (display luminance level=8), the display luminance of the LCD 17 is switched from the maximum display luminance value in the battery-operated mode, 380 candles/square meter, to the maximum display luminance value in the AC-operated mode, 600 candles/square meter.

When the computer 10 is not AC-operated (NO at step S201), the BIOS determines that the computer 10 is switched from AC-operated to battery-operated because the AC adapter 125B is detached or for any other reason, and selects the second display luminance table T2 (step S203). Accordingly, the display luminance table to be used is switched from the first display luminance table T1 to the second display luminance table T2. After this, the BIOS acquires the display luminance control data corresponding to the current display luminance level having been used until just before switch to the battery-operated mode from the second display luminance table T2 and sets the acquired display luminance control data in the luminance control register 124A in the embedded controller/keyboard controller IC 124 (step S204). As a result, for example, if the current display luminance level having been used until just before switch to the battery-operated mode is the maximum display luminance level (display luminance level=8), the display luminance of the LCD 17 is switched from the maximum display luminance value in the AC-operated mode, 600 candles/square meter, to the maximum display luminance value in the battery-operated mode, 380 candles/square meter.

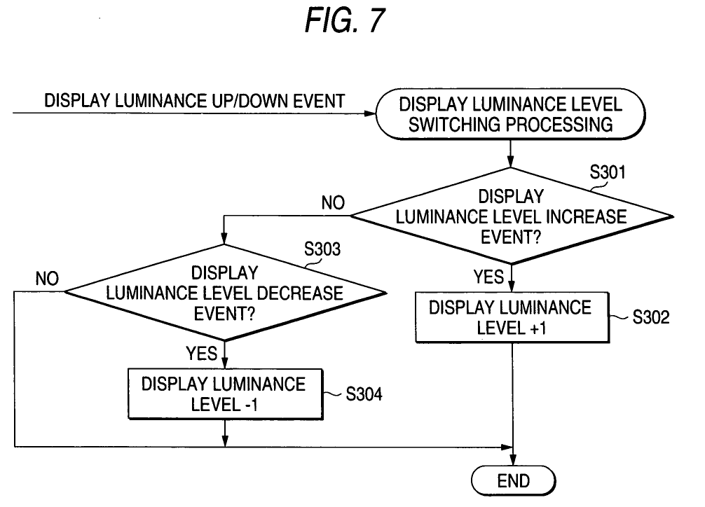

Next, display luminance level switching processing executed by the BIOS will be discussed with reference to a flowchart of FIG. 7.

The display luminance level switching processing is executed when the user operates the luminance control button 15C or 15D. When the user presses the luminance control button 15C or 15D, the embedded controller/keyboard controller IC 124 generates and sends an interrupt signal to the CPU 111 to notify the BIOS that a luminance control event (display luminance level increase event or display luminance level decrease event) is entered. The BIOS executes the following processing in response to the interrupt signal:

First, the BIOS acquires the code corresponding to the pressed button from the embedded controller/keyboard controller IC 124 and determines which one of the luminance control buttons 15C and 15D the pressed button is (step S301, S303).

If the pressed button is the luminance control button 15C, namely, a display luminance increase event is entered (YES at step S301), the BIOS executes processing of incrementing the current display luminance level by one level (step S302). At step S302, the BIOS acquires the display luminance control data corresponding to the display luminance level one level higher than the current display luminance level from the currently selected display luminance table. The BIOS sets the acquired display luminance control data in the luminance control register 124A in the embedded controller/keyboard controller IC 124. If the current display luminance level is the maximum display luminance level defined in the currently selected display luminance table, the processing at step S302 is skipped. Therefore, in the battery-operated mode, the upper limit of the display luminance value of the LCD 17 is limited to the luminance value corresponding to the maximum display luminance level defined in the second display luminance table T2 (380 candelas/square meter).

If the pressed button is the luminance control button 15D, namely, a display luminance decrease event is entered (YES at step S303), the BIOS executes processing of decrementing the current display luminance level by one level (step S304). At step S304, the BIOS acquires the display luminance control data corresponding to the display luminance level one level lower than the current display luminance level from the currently selected display luminance table. The BIOS sets the acquired display luminance control data in the luminance control register 124A in the embedded controller/keyboard controller IC 124. If the current display luminance level is the minimum display luminance level defined in the currently selected display luminance table, the processing at step S304 is skipped.

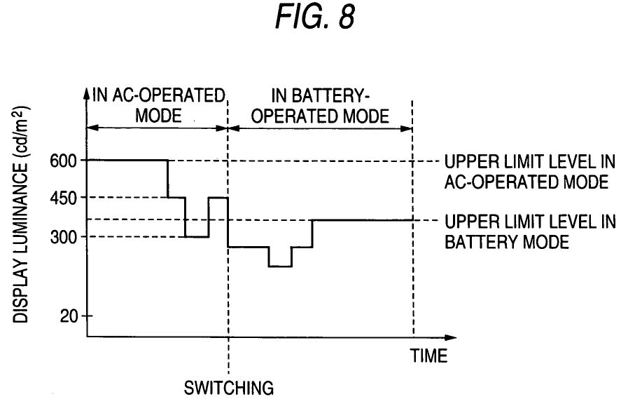

Next, a manner in which the luminance of the backlight 18 changes will be discussed with reference to FIG. 8. The heavy solid line shown in FIG. 8 indicates the display luminance value at points in time. Now, the luminance of the backlight 18 of the computer 10 is set to the display luminance value 600 candles/square meter corresponding to the maximum display luminance level of the upper limit in the AC-operated mode. As the user presses the luminance control button 15D twice, the display luminance level is lowered from the display luminance value 600 candles/square meter corresponding to the maximum display luminance level 8 to the display luminance value 450 candles/square meter corresponding to the display luminance level 7, further to the display luminance value 300 candles/square meter corresponding to the display luminance level 6. At the next point in time, as the user presses the luminance control button 15C once, the display luminance level is again increased from the display luminance value 300 candles/square meter corresponding to the display luminance level 6 to the display luminance value 450 candles/square meter corresponding to the display luminance level 7.

Next, at the switching time from the ac-operated mode to the battery-operated mode, the display luminance table to be used is switched from the first display luminance table T1 to the second display luminance table T2. The display luminance level at this time becomes the current display luminance level until just before switch to the battery-operated mode. In this case, the display luminance value corresponding to the display luminance level 7 defined in the first display luminance table T1 is 450 candelas/square meter and the display luminance value corresponding to the display luminance level 7 defined in the second display luminance table T2 is 280 candelas/square. Therefore, the luminance of the backlight 18 is switched to 280 candelas/square.

Still after switch to the battery-operated mode, as the user presses the luminance control button 15D, the luminance of the backlight 18 is lowered from the display luminance value 280 candles/square meter corresponding to the display luminance level 7 to the display luminance value 190 candles/square meter corresponding to the display luminance level 6. Further, at the next point in time, as the user presses the luminance control button 15C twice, the display luminance level is again increased from the display luminance value 190 candles/square meter corresponding to the display luminance level 6 to the display luminance value 280 candles/square meter corresponding to the display luminance level 7, further to the display luminance value 380 candles/square meter corresponding to the maximum display luminance level 8.

As described above, in the embodiment, the display luminance table to be used is automatically selected depending on the type of supply power. The maximum display luminance value defined in the second display luminance table T2 selected in the battery-operated mode is lower than the maximum display luminance value defined in the first display luminance table T1 selected in the AC-operated mode. Therefore, if the display luminance value of the display is increased to the maximum as the user operates the luminance control button 15C, it is made possible to prevent occurrence of trouble such that the operation speed of the computer is remarkably decreased.

Predetermined keys on the keyboard can also be used in combination to enter a luminance control event in place of the luminance control buttons 15C and 15D. It is not necessary that the minimum display luminance value defined in the first display luminance table T1 and the minimum display luminance value defined in the second display luminance table T2 are the same. That is, the following relation needs only to hold: The maximum display luminance value in the second display luminance table T2 is smaller than the maximum display luminance value in the first display luminance table T1 and the minimum display luminance value in the second display luminance table T2 is smaller than the maximum display luminance value in the second display luminance table T2.

It is to be understood that the invention is not limited to the specific embodiment described above and that the invention can be embodied with the components modified without departing from the spirit and scope of the invention. The invention can be embodied in various forms according to appropriate combinations of the components disclosed in the embodiment described above. For example, some components may be deleted from all components shown in the embodiment. Further, the components in different embodiments may be used appropriately in combination.

What is claimed is:

1. An information processing apparatus operated with at least one of a battery and an external power supply, the information processing apparatus comprising:
a display device;
an input unit that inputs an event instructing to change display luminance of the display device;
a determining unit that determines as to which one of the battery and the external power supply drives the information processing apparatus; and
a processing unit that changes the display luminance of the display device in a range of a first luminance value to a second luminance value being larger than the first luminance value in accordance with the event input from the input unit when the determining unit determines that the external power supply drives the information processing apparatus, the processing unit changing the display luminance of the display device in a range of a third luminance value being smaller than the second luminance value to a fourth luminance value being larger than the third luminance value and being smaller than the second luminance value in accordance with the event input from the input unit when the determining unit determines that the battery drives the information processing apparatus.

2. The apparatus according to claim 1, wherein:
the display device includes a lighting unit; and
the processing unit changes luminance of the lighting unit as the display luminance of the display device.

3. The apparatus according to claim 1, further comprising:
a storing unit that stores first information defining the first luminance value and the second luminance value, the storing unit storing second information defining the third luminance value and the fourth luminance value, wherein:
the processing unit changes the display luminance of the display device with using the first information stored in the storing unit when the determining unit determines that the external power supply drives the information processing apparatus; and
the processing unit changes the display luminance of the display device with using the second information stored in the storing unit when the determining unit determines that the battery drives the information processing apparatus.

4. The apparatus according to claim 1, wherein the fourth luminance value is determined on a basis of a value obtained by subtracting total consumption current value of components, making up the information processing apparatus, other than the display device from a current capacity value of the battery.

5. The apparatus according to claim 1, further comprising:
a casing on which the input unit is disposed, wherein the input unit includes a button switch instructing one of increasing and decreasing of the display luminance of the display device.

6. An information processing apparatus operated with at least one of a battery and an external power supply, the information processing apparatus comprising:
a display device that comprises a lighting unit;
an input unit that inputs an event instructing to change luminance of the lighting unit;
a determining unit that determines as to which one of the battery and the external power supply drives the information processing apparatus;
a setting unit that sets the luminance of the lighting unit to a specified luminance value from among a plurality of luminance values being in a range of a first luminance value to a second luminance value being larger than the first luminance value in accordance with the event input from the input unit when the determining unit determines that the external power supply drives the information processing apparatus, the setting unit setting the luminance of the lighting unit to a specified luminance value from among a plurality of luminance values being in a range of a third luminance value being smaller than the second luminance value to a fourth luminance value being larger than the third luminance value and being smaller than the second luminance value in accordance with the event input from the input unit when the determining unit determines that the battery drives the information processing apparatus; and
a controller that changes the luminance of the lighting unit on a basis of the set luminance value.

7. The apparatus according to claim 6, further comprising:
a storing unit that stores first information defining the plurality of luminance values being in a range of the first luminance value to the second luminance value, the storing unit storing second information defining the plurality of luminance values in a range of the third luminance value to the fourth luminance value, wherein:
the setting unit comprises:
a first unit that sets the luminance of the lighting unit in the range of the first luminance value to the second luminance value on a basis of the first information stored in the storage unit and the input even when the external power supply drives the information processing apparatus and the even is input; and
a second unit that sets the luminance of the lighting unit in a range of the third luminance value to the fourth luminance value on a basis of the second information stored in the storage unit and the input even when the battery drives the information processing apparatus and the even is input.

8. The apparatus according to claim 6, wherein the fourth luminance value is determined on a basis of a value obtained by subtracting total consumption current value of other components making up the information processing apparatus than the display device from a current capacity value of the battery.

9. The apparatus according to claim 1, further comprising:
a casing on which the input unit is disposed, wherein the input unit includes a button switch instructing one of increasing and decreasing of the display luminance of the display device.

10. A method for controlling display luminance of a display device provided on an information processing apparatus, the method comprising:
inputting an event instructing to change the display luminance of the display device;
determining as to which one of a battery and an external power supply drives the information processing apparatus;
changing the display luminance of the display device in a range of a first luminance value to a second luminance value being larger than the first luminance value in accordance with the input event when it is determined that the external power supply drives the information processing apparatus; and
changing the display luminance of the display device in a range of a third luminance value being smaller than the second luminance value to a fourth luminance value being larger than the third luminance value and being smaller than the second luminance value in accordance with the input event when it is determined that the battery drives the information processing apparatus.

11. The method according to claim 10, wherein:
the display device includes a lighting unit;
the changing of the display luminance of the display device in the range of the first luminance value to the second luminance value comprises controlling luminance of the lighting unit; and
the changing of the display luminance of the display device in the range of the third luminance value to the fourth luminance value comprises controlling the luminance of the lighting unit.

12. The method according to claim 10, wherein:
the information processing apparatus further comprises a storage unit that stores:
first information defining the first luminance value and the second luminance value; and
second information defining the third luminance value and the fourth luminance value;
the changing of the display luminance of the display device in the range of the first luminance value to the second luminance value comprises changing the display luminance of the display device on a basis of the first information; and
the changing of the display luminance of the display device in the range of the third luminance value to the fourth luminance value comprises changing the display luminance of the display device on a basis of the second information.

13. The apparatus according to claim 1, wherein the fourth luminance value is determined on a basis of a value obtained by subtracting total consumption current value of other components making up the information processing apparatus than the display device from a current capacity value of the battery.
